(19) United States
(12) Patent Application Publication
(10) Pub. No.: US 2024/0273116 A1
(43) Pub. Date: Aug. 15, 2024

(54) Method and System for Constructing Data Warehouse Based on Wireless Communication Network, and Device and Medium

(71) Applicant: PURPLE MOUNTAIN LABORATORIES, Nanjing, Jiangsu (CN)

(72) Inventors: Bingzhi ZHANG, Nanjing, Jiangsu (CN); Shiwen HE, Nanjing, Jiangsu (CN); Yunshan YI, Nanjing, Jiangsu (CN); Liangpeng WANG, Nanjing, Jiangsu (CN); Xiangwu ZHANG, Nanjing, Jiangsu (CN); Yongming HUANG, Nanjing, Jiangsu (CN); Xiaohu YOU, Nanjing, Jiangsu (CN)

(21) Appl. No.: 18/568,274

(22) PCT Filed: Dec. 29, 2021
(86) PCT No.: PCT/CN2021/142266

§ 371 Date: Dec. 7, 2023

(30) Foreign Application Priority Data
Jun. 8, 2021 (CN) 202110634448.9

(51) Int. Cl. G06F 16/28; G06F 16/2458; G06N 5/025

(52) U.S. Cl. CPC G06F 16/283; G06F 16/2465; G06F 16/285; G06N 5/025

(57) ABSTRACT

Disclosed is a method for constructing a data warehouse based on a wireless communication network, which includes: preprocessing original data to generate an original data table, and a KPI data table; performing knowledge extraction on the original data table and the KPI data table, and obtaining an initial data classification model by means of endogenous association inference; splitting the original data table and the KPI data table according to the initial data classification model, so as to construct initially classified basic summary data tables; performing association inference on the initial data classification model so as to output associated fields, calculating weights of associations between the associated fields and sorting the weights, and outputting a preferential association model; and performing, according to the preferential association model, data extraction, transformation and loading from the basic summary data tables, so as to generate a data warehouse for the demand fields.

### CROSS-REFERENCE TO RELATED APPLICATION

The disclosure claims priority to Chinese Patent Application No. 202110634448.9, filed to the China National Intellectual Property Administration on Jun. 8, 2021 and entitled “Method and System for Constructing Data Warehouse Based on Wireless Communication Network, and Device and Medium”, the disclosure of which is hereby incorporated by reference in its entirety.

### TECHNICAL FIELD

The disclosure relates to the technical field of intelligent wireless communication networks, in particular to a method and system for constructing data warehouse based on a wireless communication network, and a device and a medium.

### BACKGROUND

Wireless communication refers to long-distance transmission communication between a plurality of nodes, by which transmission is performed without conductors or cables. Commercial wireless communication has developed from the initial 1G to the current 5G, and the future 6G, the traffic bandwidth of communication is becoming larger and larger, and the function is becoming more and more powerful. A wireless communication network involves a lot of complex data, including thousands of data fields and indicators, from the user terminal and the access network to a core network. The complex data involves different hardware and software, functions, and protocol stacks. By effectively collecting and reasonably using all kinds of data formed during the operation of the wireless communication network, the service potential of wireless communication network is maximized, and the further development of the technical advantages of the wireless communication network is promoted.

With the continuous progress of big data and artificial intelligence technology, the wireless communication is promoted to develop towards intelligence, however the precondition of achieving the intelligence wireless communication is the wireless big data. The acquisition of wireless communication data is mainly completed by telecom operators, telecom device providers and application service providers. Acquisition nodes include smart phones and various sensors on a terminal side, macro/micro base stations on an access side, and dedicated data acquisition units on a core network side. Acquisition means include raw data recording, Deep Packet Inspection (DPI), etc.

A data warehouse is a data set that integrates, classifies, analyzes and utilizes the original data acquired for specific analysis demand cases. Traditional data warehouse is constructed by data modeling based on the existing domain knowledge, and in face to the wireless communication network data with relatively complex associations, data that meets the analysis demands cannot be extracted completely and accurately, thereby affecting the accuracy of analysis results.

### SUMMARY

According to various embodiments of the disclosure, a method and system for constructing data warehouse based on a wireless communication network, and a device and a medium are provided.

In one aspect, a method for constructing a data warehouse based on a wireless communication network is provided, which includes: preprocessing original data to generate an original data table, and summarizing Key Performance Indicators (KPIs) from the original data based on different time granularities and dimensions, so as to generate a KPI data table; performing knowledge extraction on the original data table and the KPI data table, constructing an association rule, generating a knowledge graph, and obtaining an initial data classification model by means of endogenous association inference; splitting the original data table and the KPI data table according to the initial data classification model, so as to construct initially classified basic summary data tables, the basic summary data tables including original data sub-tables and KPI data sub-tables of different classes; performing association inference on the initial data classification model according to demand fields, which are input by a user, so as to output associated fields, calculating weights of associations between the associated fields and sorting the weights, and outputting a preferential association model; and performing, according to the preferential association model, data extraction, transformation and loading from the basic summary data tables, so as to generate a data warehouse for the demand fields, information associated with the demand fields being summarized in the data warehouse.

In one embodiment, the dimensions include a user dimension, a cell dimension and a procedure dimension.

In one embodiment, the original data includes data of an access network and data of a core network of the wireless communication network. The original data is acquired through acquisition software, and stored to a data platform which is based on hive software architecture. The acquired original data is partitioned and stored according to the time range through the elimination of null values and invalid values.

In one embodiment, the operation of performing knowledge extraction on the preprocessed data includes: performing knowledge extraction by using corresponding associations between fields of the original data table and KPI fields of the KPI data table, summarizing and integrating the fields of the original data table obtained after preprocessing and the KPI fields of the KPI data table into a plurality of vector matrices, and initializing the weights in each vector matrix.

In one embodiment, the operation of constructing the association rule and generating the knowledge graph includes: determining the association rule based on a wireless communication network protocol, defining the strength of the associations by using different weights according to the association rule, and assigning the weights to the plurality of vector matrices generated by knowledge extraction; and splitting the plurality of vector matrices into a plurality of triplets, each of which contains two associated fields and the weight in the vector matrix, and storing the triplets in the form of a graph, so as to generate a knowledge graph of the associations between the plurality of fields.

In one embodiment, the assignment of the weights is input and filled through a visual interface or is loaded in bulk in the form of a text file.

In one embodiment, the operation of obtaining the initial data classification model by means of endogenous association inference includes the following operation.

The fields in the original data table and the KPI data table are classified through a preset Markov logic network model association inference algorithm, so as to form the initial data classification model.

In one embodiment, performing association inference on the initial data classification model according to the demand fields, which are input by the user, so as to output the associated fields, calculating the weights of the associations between the associated fields and sorting the weights, and outputting the preferential association model includes: performing association inference on the demand fields, which are input by the user, and the initial data classification model, and obtaining a plurality of association classes associated with the demand fields in the initial data classification model, and the plurality of associated fields associated with the demand fields in each association class through analysis; calculating the weights of the associations between the associated fields associated with the demand fields, the associated fields including the associated fields of the original data table and the associated KPI fields; and sorting the associated fields in each association class according to the weights of the associations, extracting the plurality of associated fields with larger weights and the basic summary data table where they are located, storing associated field names and table names of the plurality of associated fields with larger weights according to a predetermined data structure, and outputting the preferential association model.

In one embodiment, the demand fields include a data field, a time granularity, and a field threshold.

In one embodiment, performing, according to the preferential association model, data extraction, transformation and loading from the basic summary data tables, so as to generate the data warehouse for the demand fields includes: editing a corresponding data Extract-Transform-Load (ETL) program according to the output preferential association model. The data ETL program is configured to extract corresponding associated data in line with the needs from the basic summary data tables, and respectively store the corresponding associated data in the form of KPI sub-tables of the association classes, and data sub-tables of the association classes. The KPI sub-tables of the association classes, and the data sub-tables of the association classes constitute the data warehouse for the demand fields.

In another aspect, a system for constructing a data warehouse based on a wireless communication network is provided, which includes: a data detail processing unit, an endogenous association modeling unit, a demand association inference unit, and a data warehouse construction unit.

The data detail processing unit includes a preprocessing module and a KPI summarizing module. The preprocessing module is configured to preprocess original data to generate an original data table. The KPI summarizing module is configured to summarize KPIs from the original data according to different time granularities and dimensions, so as to generate a KPI data table.

The endogenous association modeling unit is configured to perform knowledge extraction on the original data table obtained by preprocessing of the data detail processing unit and the KPI data table, construct an association rule, generate a knowledge graph, obtain an initial data classification model by means of endogenous association inference, construct initially classified basic summary data tables according to the initial data classification model, and output the basic summary data tables to the data warehouse construction unit.

The demand association inference unit is configured to perform association inference on the initial data classification model according to demand fields, which are input by a user, so as to output associated fields, calculate weights of associations between the associated fields and sort the weights, and output a preferential association model.

The data warehouse construction unit is configured to perform, according to the output preferential association model, data extraction, transformation and loading from the basic summary data tables, so as to generate a data warehouse for the demand fields. Information associated with the demand fields is summarized in the data warehouse.

In one embodiment, the dimensions include a user dimension, a cell dimension and a procedure dimension.

In one embodiment, the original data includes data of an access network and data of a core network of the wireless communication network. The original data is acquired through acquisition software and stored to a data platform which is based on hive software architecture, and is partitioned and stored according to the time range through the elimination of null values and invalid values.

In one embodiment, the endogenous association modeling unit includes a knowledge extraction module, an association rule module, a knowledge graph construction module, and an endogenous association inference module.

In one embodiment, the knowledge extraction module is configured to perform knowledge extraction on the original data table obtained by preprocessing and the KPI data table, summarize and integrate the fields of the original data table obtained after preprocessing and the KPI fields of the KPI data table into a plurality of vector matrices, and initialize the weights in each vector matrix.

The association rule module is configured to construct a slowly changing association rule based on a wireless communication network protocol, assign, according to the association rule, the weights in the plurality of vector matrices formed by the knowledge extraction module, and save the plurality of assigned vector matrices in real time.

The knowledge graph construction module is configured to split the plurality of vector matrices stored by the association rule module into a plurality of triplets, each of which contains two associated fields and the weight in the vector matrix, and store the triplets in the form of a graph, so as to generate a knowledge graph of the associations between the plurality of fields.

The endogenous association inference unit is configured to perform associated algorithm inference on the knowledge graph provided by the knowledge graph construction module based on a preset association inference algorithm, classify the fields in the original data table and the KPI data table, so as to generate the initial data classification model, split the original data table and the KPI data table according to the initial data classification model, so as to construct the initially classified basic summary data tables, and output the light aggregation data tables to the data warehouse construction unit through a back-end program.

In one embodiment, the preset association inference algorithm is based on a Markov logic network model algorithm.

In one embodiment, the assignment of the weights is input and filled through a visual interface or is loaded in bulk in the form of a text file.

In one embodiment, the demand association inference unit includes a specific demand input module, an associated field inference module, a weight sorting and preference module, and an association model output module.

The specific demand input module is configured to input specific demand fields of the user for the data warehouse. The demand fields include a data field, a time granularity, and a field threshold.

The associated field inference module is configured to perform association inference on the demand fields with the initial data classification model generated by the endogenous association modeling unit after receiving the demand fields transmitted by the specific demand input module, so as to obtain a plurality of association classes associated with the demand fields in the initial data classification model, and the plurality of associated fields associated with the demand fields in each association class, and calculate the weights of the associations between the associated fields associated with the demand fields. The associated fields include the associated fields of the original data table and the associated KPI fields.

The weight sorting and preference module is configured to sort the associated fields output by the associated field inference module according to the weights, extract the plurality of the associated fields with the top-ranked weights, and output the plurality of the associated fields with the top-ranked weights to the association model output module according to two classes, namely the fields of the original data table and the KPI fields.

The association model output module is configured to generate a preferential association model in line with the needs by combining two classes of the associated fields output by the weight sorting and preference module with the demand fields input by the specific demand input module, and transmit the preferential association model to the data warehouse construction unit.

In one embodiment, the data warehouse construction unit includes a model sub-table ETL module and an associated data extraction ETL module. The model sub-table ETL module is configured to receive the initial classification data model transmitted by the endogenous association modeling unit, and perform sub-table processing on the original data table obtained after preprocessing and the summarized KPI data table, so as to generate the plurality of basic summary data tables. The associated data extraction ETL module is configured to receive the preferential association model transmitted by the demand association inference unit, generate a plurality of associated data sub-tables according to the basic summary data tables, and construct the data warehouse for the demand fields.

In another aspect, an electronic device is provided, which includes a memory, a processor, and a computer program stored in the memory and runnable on the processor. The processor implements any of the above method for constructing data warehouse based on the wireless communication network when executing the program.

In another aspect, a computer readable storage medium is provided, on which a computer executable instruction is stored, and when executed by a processor, the computer executable instruction is configured to implement any of the above method for constructing data warehouse based on the wireless communication network.

Details of one or more embodiments of the disclosure are given in the drawings and descriptions below. Other features and advantages of the disclosure will become apparent from the description, the drawings and the claims.

### BRIEF DESCRIPTION OF THE DRAWINGS

FIG. 1 is a flowchart of a method according to an embodiment the disclosure.

FIG. 2 is a schematic structural diagram of an apparatus according to an embodiment of the disclosure.

### DETAILED DESCRIPTION OF THE EMBODIMENTS

A method and system for constructing data warehouse based on a wireless communication network, and a device and a medium of the disclosure will be further described and explained below in combination with the drawings.

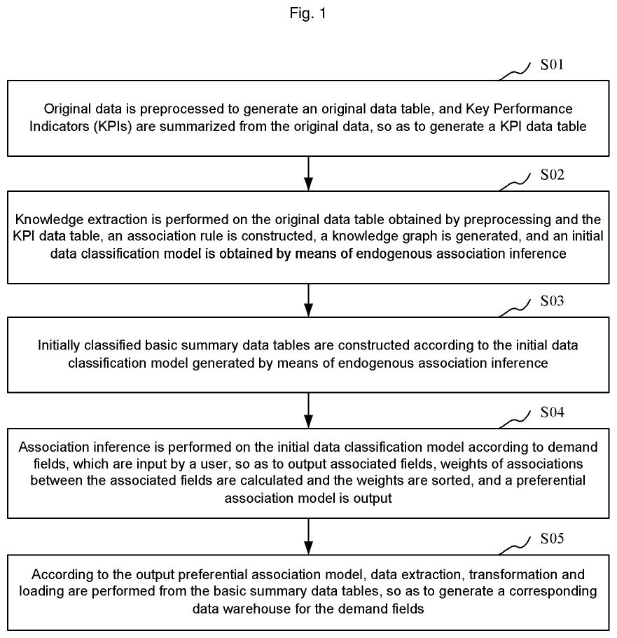

FIG. 1 shows an exemplary flowchart of a method for constructing a data warehouse based on a wireless communication network according to an embodiment of the disclosure.

The method includes the following steps.

At S01, original data is preprocessed to generate an original data table, and KPIs are summarized from the original data, so as to generate a KPI data table.

The KPIs are summarized based on different time granularities and dimensions. The dimensions include a user dimension, a cell dimension and a procedure dimension and so on. The original data includes two parts, namely data of an access network and data of a core network of the wireless communication network. The original data is acquired through various acquisition software, and stored to a data platform which is based on hive software architecture. The acquired original data is partitioned and stored according to the time range after the preliminary elimination of null values and invalid values. Then, the KPIs of all kinds of original data are calculated at different time granularities, so as to generate the corresponding KPI data table.

Taking communication data in the original data table as an example, based on the time granularity per unit time, the number of successes and failures of different communication procedures in the original data table per unit time are counted, and the KPIs are summarized. The KPIs include: the number of registration successes, the number of registration failures, the number of User Equipment (UE) authentication successes, the number of UE authentication failures, the number of Protocol Data Unit (PDU)_Session resource establishment request successes, the number of PDU_Session resource establishment request failures, the number of 5th Generation Mobile Communication Technology (5G) switching out successes, and the number of 5G switching out failures.

In one embodiment, data of an N1 interface of the core network is taken as the original data, and signaling procedure classification of the N1 data is shown in Table 1 below.

TABLE 1

| Procedure name | Description |
|---|---|
| Registration | Registration |
| De-registration | De-registration |
| Service request | Service request |
| Notification | Notification |
| Primary authentication and key agreement | Authentication |
| Security mode control | Security mode control |
| Identification | Identification |
| Generic UE configuration update | Update |
| 5GMM status | Mobility management status |
| PDU session establishment | PDU session establishment |
| PDU session authentication | PDU session authentication |
| and authorization | |
| PDU session modification | PDU session modification |
| PDU session release | PDU session release |
| 5GSM status | Session management status |

As shown in Table 1 above, redundant fields of a data wide table of N1 are removed through dirty data processing. At the same time, statistics is respectively performed on different single-class signaling, such as the number of successes and failures of a registration procedure in 15 minutes, one hour, and one day, so as to form the statistical data of the KPIs in different time granularities, and the statistical data is imported into the corresponding KPI data table.

The method for constructing the data warehouse based on the wireless communication network provided by the disclosure may be applied to different network protocols according to the source of the original data. For example, the original data includes wireless communication data which may be applied not only the layer above a network layer, but also in a physical layer and a data link layer.

At S02, knowledge extraction is performed on the original data table obtained by preprocessing and the KPI data table, an association rule is constructed, a knowledge graph is generated, and an initial data classification model is obtained by means of endogenous association inference.

Endogenous association refers to associations hidden between elements in an object, including associations hidden among the fields of the original data table and the KPI fields of the KPI data table. Endogenous association analysis refers to the mining of associations hidden among some data and indicators through the methods such as establishment of data and graph structure analysis models, wherein the data and indicators are stipulated in a protocol in the wireless communication network, and reflect and affect the flow of service data and network performance.

The fields of the original data table obtained after preprocessing and the KPI fields of the KPI data table are taken as knowledge of the wireless communication network. There are distant or close associations between these fields, and knowledge extraction is performed by using the associations between the fields. For example, changes in a certain field value of the original data may affect changes in some other field values. The KPI fields are obtained by summarizing the information of some fields of the original data, and the changes in the field values of some fields of the original data may also affect the changes in the field values of the KPI fields. The KPI fields are also affected each other. The changes in the field value of one KPI field may cause the changes in the field values of some other KPI fields.

Through knowledge extraction, the fields of the original data table obtained after preprocessing and the KPI fields of the KPI data table are summarized and integrated into a plurality of vector matrices, and the weights in each vector matrix are initialized, for example, the initial values of the weights are set to 0.

The association rule is determined based on a wireless communication network protocol, including the understanding of a 3rd Generation Partnership Project (3GPP) protocol and industry norms. The strength of the associations may be defined by using different weights according to the association rule, and the weights are assigned to the plurality of vector matrices generated by knowledge extraction. That is, after using a certain slowly changing association rule, the weights are assigned, as shown in Table 2 below, w represents the weight between the two fields.

TABLE 2

| | Field 1 | Field 2 | Field 3 | . . . | Field N |
|---|---|---|---|---|---|
| Field 1 | 0 | w₁₂ | w₁₃ | | w₁ₙ |
| Field 2 | w₁₂ | 0 | w₂₃ | | w₂ₙ |
| Field 3 | w₁₃ | w₂₃ | 0 | | w₃ₙ |
| . . . | . . . | . . . | . . . | 0 | . . . |
| Field N | w₁ₙ | w₂ₙ | w₃ₙ | | 0 |

These vector matrices are split into a plurality of triplets, each of the plurality of triplets contains two associated fields and the weight in the vector matrix. For example, the triplet between the field 1 and field 2 is expressed as (field 1, weight w₁₂, field 2). The triplet is stored in the form of a graph. A knowledge graph of the associations between the plurality of fields is generated by combining different algorithms, such as a K-means algorithm.

In one embodiment of the disclosure, a graph triplet (triplet stored in the form of the graph) is stored by using an Neo4j graph database. In the disclosure, a complex relation of the wireless communication network is effectively clarified, and by mining endogenous associations between the fields hidden behind the data, the relations between various data fields in the wireless communication network are represented in the form of the knowledge graph.

After the knowledge graph is generated, the fields in the original data table and the KPI data table are classified into a plurality of classes by using a preset association inference algorithm, such as a Markov logic network model association inference algorithm. These classes form one initial data classification model for the original data table obtained after preprocessing and the KPI data table.

In one embodiment, the data of the N1 interface of the core network is taken as the original data, and the original data table and the KPI data table are generated by preprocessing the data of the N1 interface of the core network. The original data table contains fields of the data of the N1 interface, and the KPI data table contains the KPI fields. The fields of the data of the N1 interface and the KPI fields contain more than 100 fields. Endogenous correlation inference is performed on these more than 100 fields to acquire associations hidden between the fields of the data of the N1 interface and the KPI fields, as to generate the initial data classification model. In the embodiment, the fields of the data of the N1 interface and the KPI fields are classified into the plurality of classes through the Markov logic network model association inference algorithm, and then the initial data classification model is generated. In the embodiment, the generated initial data classification model is partially shown in Table 3 below.

TABLE 3

| | |
|---|---|
| Class 1 | PDU session-related fields and few other fields |
| Class 2 | Indicators of registration procedure, PDU session-related procedure, paging |
| | procedure, and authentication procedure |
| Class 3 | Algorithm class data indicators |
| Class 4 | Public fields, message identifiers, status identifiers, amf, and few other fields |
| Class 5 | Qos-related fields |
| Class 6 | Some related fields related to Short Messaging Services (SMSs) |
| Class 7 | Most procedures except registration, de-registration, and PDU session-related |
| | procedures |
| Class 8 | De-registration-related fields and few other fields |

At S03, initially classified basic summary data tables are constructed according to the initial data classification model generated by means of endogenous association inference.

After the initial data classification model generated by means of endogenous association inference is obtained, the original data table obtained after preprocessing and the KPI table are split to generate original data sub-tables and KPI data sub-tables of different classes, which are defined as the initially classified basic summary data tables and used as basic data for subsequent association inference processing.

At S04, association inference is performed on the initial data classification model according to demand fields, which are input by a user, so as to output associated fields, weights of associations between the associated fields are calculated and the weights are sorted, and a preferential association model is output.

The basic summary data tables cannot be directly used as analysis data for providing specific applications, and need to be further processed in combination with specific application needs before being used. A data consumer, that is, the user, puts forward the specific demand fields of the data warehouse based on traditional communication knowledge, and inputs the demand fields. The demand fields include a data field, a time granularity, and a field threshold. Association interference is performed on these demand fields and the initial data classification model, so as to analyze which associated fields in which data classes are associated with the demand fields. The associated fields here include the fields of the original data table and the KPI fields.

In one embodiment, S04 includes the following operation: association inference is performed on the demand fields, which are input by the user, with the initial data classification model, a plurality of association classes associated with the demand fields in the initial data classification model, and a plurality of associated fields associated with the demand fields in each association class are obtained through analysis; the weights of the associations between all the associated fields associated with the demand fields are calculated, wherein the associated fields include the fields of the original data table and the KPI fields; and the associated fields in each association class are sorted according to the weights of the associations, the plurality of associated fields with larger weights and the basic summary data table where they are located are extracted, and associated field names and table names of the plurality of associated fields with the larger weights are stored according to a predetermined data structure, and the preferential association model is output.

Exemplarily, by using the data of the N1 interface of the core network as the original data, for the analysis needs for the N1 data, the analysis shows that M data classes are associated with the demand fields, which are called association class 1, association class 2, . . . , association class M. The plurality of associated fields in each association class are associated with the demand fields, and the weights of the associations are calculated. The associated fields in each association class are sorted according to the weights of the associations, and the plurality of top-ranked fields are selected, for example, the first 10 fields with the top-ranked weights are selected. These 10 fields may have both original data fields and KPI fields. These two classes of fields and the basic summary data tables where the fields are located are extracted and stored in a certain data structure, so as to form the preferential association model in line with the needs.

At S05, according to the output preferential association model, data extraction, transformation and loading are performed from the basic summary data tables, so as to generate a data warehouse for the demand fields.

Information associated with the demand fields is summarized in the generated data warehouse. For example, all the information associated with the demand fields is summarized to facilitate a data analyst to analyze and apply the data more accurately and directly according to the data warehouse.

In one embodiment, after acquiring the preferential association model in line with the demands, the corresponding associated data in line with the application needs is extracted from the basic summary data tables by editing a corresponding ETL program. The corresponding associated data is respectively stored in the form of KPI sub-tables of the association classes, and data sub-tables of the association classes. The KPI sub-tables of the association classes, and the data sub-tables of the association classes constitute the data warehouse for the demand fields, which is convenient for the data analyst to analyze and apply the data more accurately and directly.

In the disclosure, the associated fields in line with different needs are analyzed by means of association interference, so that effective information of a data warehouse subject of the wireless communication network is effectively improved, the data warehouse for the demand fields is generated. All the information associated with the demand fields is summarized in the data warehouse, thereby improving the accuracy of later data processing, and providing more valuable reference fields for researchers. At the same time, the waste of time and energy on some invalid information is avoided, which facilitates the researchers to perform more targeted data analysis and research, and provides more powerful support for the research on performance improvement and optimization of the wireless communication network. In addition, the disclosure is conducive to the performance optimization of the wireless network. For example, in a scenario of fault detection, the data warehouse constructed by the disclosure provides more targeted and more comprehensive and accurate data analysis for fault detection.

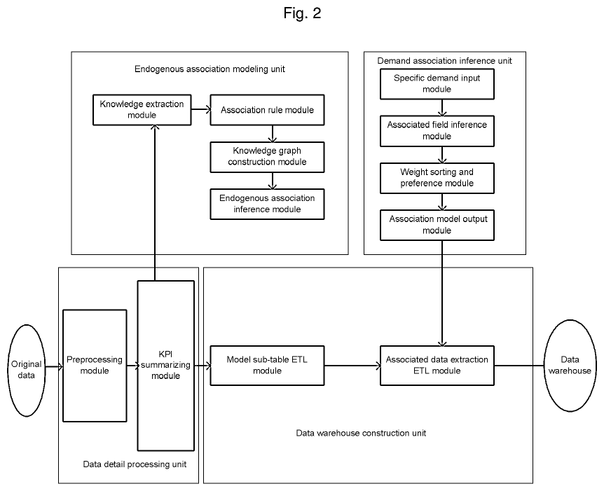

Further reference is made to FIG. 2, which shows a structural block diagram of a system for constructing a data warehouse based on a wireless communication network according to an embodiment. The system includes: a data detail processing unit, an endogenous association modeling unit, a demand association inference unit, and a data warehouse construction unit.

The data detail processing unit includes a preprocessing module and a KPI summarizing module. The preprocessing module is configured to preprocess original data to generate an original data table. The original data includes two parts, namely data of an access network and data of a core network of the wireless communication network. The original data is acquired through various acquisition software and stored to a data platform which is based on hive software architecture. In the preprocessing module, an execution script of hive is written in shell language, then executed on time by using a scheduling tool to complete related processing periodically, and the processed data is stored in a hive data platform. The KPI summarizing module is configured to summarize KPIs from the original data, so as to generate a KPI data table.

The endogenous association modeling unit includes a knowledge extraction module, an association rule module, a knowledge graph construction module, and an endogenous association inference module. The endogenous association modeling unit is configured to perform knowledge extraction on the original data table obtained by preprocessing of the data detail processing unit and the KPI data table, store a corresponding association rule in the form of a graph, construct a knowledge graph, and finally obtain an initial data classification model by means of endogenous association inference and output the initial data classification model.

In one embodiment, the knowledge extraction module is configured to summarize and integrate various fields of various original data tables obtained by preprocessing and the KPI fields of the KPI data table into a plurality of vector matrices according to traditional knowledge in the field of communications, and initialize the weights in each vector matrix. That is, before constructing the association rule, the weights in the vector matrices are set to 0.

The association rule module is configured to construct a slowly changing association rule, including assigning the weights in the vector matrices formed by the knowledge extraction module based on a wireless communication network protocol, and saving the assigned vector matrices in real time.

In one embodiment, the assignment of the weights is input and filled through a visual interface or is loaded in bulk in the form of a text file.

The knowledge graph construction module is configured to split the plurality of vector matrices stored by the association rule module into a plurality of triplets, wherein each of the plurality of triplets contains two associated fields and the weight in the vector matrix. This is to store the associations between the fields of the original data table and the KPI fields in a graph database software in the form of a graph according to the vector matrix stored by the association rule module, and the associations combine with different data algorithms to generate triplet information of the KPI and algorithm types, expressed as (attribute field, effective relation, statistical indicator), (statistical indicator, algorithm relation, algorithm type data indicator). The effective relation and the algorithm relation in the triplet are expressed in the form of weights and stored in the graph database to construct a knowledge graph required for endogenous association inference.

In one embodiment, by taking a signaling procedure as an example, a graph triplet of an association rule is expressed as (procedure type, procedure relation, attribute field), and the procedure stores the plurality of triplets according to the attribute fields involved.

The endogenous association inference unit is configured to perform related algorithm inference on the knowledge graph provided by the knowledge graph construction module based on a preset association inference algorithm, wherein the preset association inference algorithm may be a Markov logic network model algorithm; correspondingly classify the fields in the original data table and the KPI data table to generate the initial data classification model; and split the original data table and the KPI data table according to the initial data classification model, so as to construct the initially classified basic summary data tables, and output the light aggregation data tables to the data warehouse construction unit through a back-end program.

The demand association inference unit is configured to perform association inference on the demand fields with the initial data classification model generated by the endogenous association modeling unit after receiving the specific demand fields input by the user, so as to obtain the corresponding preferential association model and output same to the data warehouse construction unit, wherein the demand association inference unit includes a specific demand input module, an associated field inference module, a weight sorting and preference module, and an association model output module.

The specific demand input module is a software module displayed on a front end, and configured to input specific demand fields of the user for the data warehouse. The demand fields include, but are not limited to, a data field, a time granularity, and a field threshold.

The associated field inference module is configured to perform association inference on the demand fields with the initial data classification model generated by the endogenous association modeling unit based on a preset algorithm, such as a Markov logic network model algorithm, after receiving the demand fields transmitted by the specific demand input module, so as to obtain a plurality of association classes of the demand fields in the initial data classification model, and weights of the associated fields of the original data table and the associated KPI fields in the plurality of association classes.

The weight sorting and preference module is configured to sort the associated fields output by the associated field inference module according to the weights, select the plurality of the associated fields with the top-ranked weights, and output the plurality of the selected associated fields with the top-ranked weights to the association model output module according to two classes, namely the fields associated with the original data table and the associated KPI fields.

The association model output module is configured to generate a preferential association model in line with the needs by combining two classes of the associated fields with the demand fields, and transmit the preferential association model to the data warehouse construction unit, wherein the two classes of the associated field are output by the weight sorting and preference module, and the demand fields are input by the specific demand input module under the conditions such as the time granularity and the field threshold.

The data warehouse construction unit includes a model sub-table ETL module and an associated data extraction ETL module, which are respectively configured to receive data models transmitted by the endogenous association modeling unit and the demand association inference unit, perform two-stage processing, and finally generate the data warehouse.

The model sub-table ETL module is configured to receive the initial classification data model transmitted by the endogenous association modeling unit, and perform sub-table processing on the original data table obtained after preprocessing and the summarized KPI data table, so as to generate the plurality of basic summary data tables.

The associated data extraction ETL module is configured to receive the preferential association model transmitted by the demand association inference unit, operate the basic summary data tables to generate a plurality of associated data sub-tables, and construct the data warehouse for the demand fields.

In one embodiment, the ETL script is the processing script which is generated by the back-end program according to the data model, and then the ETL script is executed periodically by scheduling software after the execution cycle is configured on the front end.

Part or all of modules of the above method for constructing the data warehouse based on the wireless communication network may be implemented by means of software, hardware and a combination thereof. The above modules are embedded in the hardware form or independent of a processor in a server, and are also stored in a memory of the server in the software form, so that the processor calls and executes operations corresponding to the above modules.

An electronic device is provided, which includes a memory, a processor, and a computer program stored in the memory and runnable on the processor. The processor implements the method for constructing the data warehouse based on the wireless communication network as described in any of the above embodiments when executing the program. The memory may be of various types, which may be a Random Access Memory (RAM), a Read Only Memory (ROM), a flash memory, etc. The processor may be of various types, for example, a central processing unit, a microprocessor, a digital signal processor, or an image processor.

A computer readable storage medium is provided, on which a computer executable instruction is stored, and when executed by a processor, the computer executable instruction is configured to implement the method for constructing the data warehouse based on the wireless communication network as described in any of the above embodiments. The storage medium includes: various media capable of storing program codes such as a USB disk, a mobile hard disk drive, an ROM, an RAM, a magnetic disk or a compact disc.

As used herein, terms such as “component”, “module”, and “system” are intended to represent computer-related entities, which can be hardware, a combination of hardware and software, software, or software in execution. For example, a component may be, but is not limited to, a process running on a processor, the processor, an object, an executable code, a thread of execution, a program, and/or a computer. As an illustration, both an application running on a server and the server can be components. One or more components can reside within the process and/or thread of execution, and the component can be located in one computer and/or distributed between two or more computers.

The above description is merely preferred implementation modes of the disclosure, and it is to be noted that those of ordinary skill in the art may also make several improvements and refinements without departing from the principle of the disclosure, and it should be considered that these improvements and refinements shall all fall within the scope of protection of the disclosure.

What is claimed is:

1. A method for constructing a data warehouse based on a wireless communication network, comprising:
preprocessing original data to generate an original data table, and summarizing Key Performance Indicators (KPIs) from the original data based on different time granularities and dimensions, so as to generate a KPI data table;
performing knowledge extraction on the original data table and the KPI data table, constructing an association rule, generating a knowledge graph, and obtaining an initial data classification model by means of endogenous association inference;
splitting the original data table and the KPI data table according to the initial data classification model, so as to construct initially classified basic summary data tables, the basic summary data tables comprising original data sub-tables and KPI data sub-tables of different classes;
performing association inference on the initial data classification model according to demand fields which are input by a user, so as to output associated fields, calculating weights of associations between the associated fields and sorting the weights, and outputting a preferential association model; and
performing, according to the preferential association model, data extraction, transformation and loading from the basic summary data tables, so as to generate a data warehouse for the demand fields, information associated with the demand fields being summarized in the data warehouse.

2. The method as claimed in claim 1, wherein the dimensions comprise a user dimension, a cell dimension and a procedure dimension.

3. The method as claimed in claim 1, wherein the original data comprises data of an access network and data of a core network of the wireless communication network, wherein the original data is acquired and stored to a data platform based on hive software architecture through an acquisition software, wherein the acquired original data is partitioned and stored according to a time range through an elimination of null values and invalid values.

4. The method as claimed in claim 1, wherein the performing knowledge extraction on the original data table and the KPI data table comprises:
performing knowledge extraction according to corresponding associations between fields of the original data table and KPI fields of the KPI data table, summarizing and integrating the fields of the original data table and the KPI fields of the KPI data table into a plurality of vector matrices, and initializing weights in each vector matrix.

5. The method as claimed in claim 4, wherein the constructing the association rule and generating the knowledge graph comprises:
determining the association rule based on a wireless communication network protocol, defining strengths of the associations by different weights according to the association rule, and assigning the weights to the plurality of vector matrices generated by the knowledge extraction; and
splitting the plurality of vector matrices into a plurality of triplets, wherein each of the plurality of triplets contains two associated fields and the weight in the vector matrix, and storing the triplets in a form of a graph, so as to generate a knowledge graph of the associations between a plurality of fields.

6. The method as claimed in claim 5, wherein an assignment of the weights is input and filled through a visual interface or is loaded in bulk in a form of a text file.

7. The method as claimed in claim 1, wherein the obtaining the initial data classification model by means of endogenous association inference comprises:
classifying fields in the original data table and the KPI data table through an association inference algorithm of a preset Markov logic network model, so as to form the initial data classification model.

8. The method as claimed in claim 1, wherein the performing association inference on the initial data classification model according to demand fields which are input by a user, so as to output associated fields, calculating weights of associations between the associated fields and sorting the weights, and outputting a preferential association model comprises:
performing association inference on the demand fields which are input by the user, with the initial data classification model, and analysing and obtaining a plurality of association classes associated with the demand fields in the initial data classification model, and a plurality of associated fields associated with the demand fields in each association class;
calculating the weights of the associations between the associated fields associated with the demand fields, the associated fields comprising the fields of the original data table and the KPI fields; and
sorting the associated fields in each association class according to the weights of the associations, extracting a plurality of associated fields with larger weights and basic summary data tables where they are located, storing associated field names and table names of the plurality of associated fields with larger weights according to a predetermined data structure, and outputting the preferential association model.

9. The method as claimed in claim 1, wherein the demand fields comprise a data field, a time granularity, and a field threshold.

10. The method as claimed in claim 1, wherein the performing, according to the preferential association model, data extraction, transformation and loading from the basic summary data tables, so as to generate the data warehouse for the demand fields comprises:
writing a corresponding data Extract-Transform-Load (ETL) program according to the output preferential association model, wherein the data ETL program is configured to extract corresponding associated data in line with needs from the basic summary data tables, and respectively store the corresponding associated data in a form of KPI sub-tables of the association classes, and data sub-tables of the association classes; and the KPI sub-tables of the association classes, and the data sub-tables of the association classes constitute the data warehouse for the demand fields.

11-18. (canceled)

19. An electronic device, comprising a memory, a processor, and a computer program stored in the memory and runnable on the processor, wherein the processor implements following actions when executing the program:
preprocessing original data to generate an original data table, and summarizing Key Performance Indicators (KPIs) from the original data based on different time granularities and dimensions, so as to generate a KPI data table;
performing knowledge extraction on the original data table and the KPI data table, constructing an association rule, generating a knowledge graph, and obtaining an initial data classification model by means of endogenous association inference;
splitting the original data table and the KPI data table according to the initial data classification model, so as to construct initially classified basic summary data tables, the basic summary data tables comprising original data sub-tables and KPI data sub-tables of different classes;
performing association inference on the initial data classification model according to demand fields which are input by a user, so as to output associated fields, calculating weights of associations between the associated fields and sorting the weights, and outputting a preferential association model; and
performing, according to the preferential association model, data extraction. transformation and loading from the basic summary data tables, so as to generate a data warehouse for the demand fields, information associated with the demand fields being summarized in the data warehouse.

20. A computer readable storage medium, on which a computer executable instruction is stored, and when executed by a processor, the computer executable instruction being configured to implement following actions:
preprocessing original data to generate an original data table, and summarizing Key Performance Indicators (KPIs) from the original data based on different time granularities and dimensions, so as to generate a KPI data table;
performing knowledge extraction on the original data table and the KPI data table, constructing an association rule, generating a knowledge graph, and obtaining an initial data classification model by means of endogenous association inference;
splitting the original data table and the KPI data table according to the initial data classification model, so as to construct initially classified basic summary data tables, the basic summary data tables comprising original data sub-tables and KPI data sub-tables of different classes;
performing association inference on the initial data classification model according to demand fields which are input by a user, so as to output associated fields, calculating weights of associations between the associated fields and sorting the weights, and outputting a preferential association model; and
performing, according to the preferential association model, data extraction, transformation and loading from the basic summary data tables, so as to generate a data warehouse for the demand fields, information associated with the demand fields being summarized in the data warehouse.

21. The electronic device as claimed in claim 19, wherein the dimensions comprise a user dimension, a cell dimension and a procedure dimension.

22. The electronic device as claimed in claim 19, wherein the original data comprises data of an access network and data of a core network of the wireless communication network, wherein the original data is acquired and stored to a data platform based on hive software architecture through an acquisition software, wherein the acquired original data is partitioned and stored according to a time range through an elimination of null values and invalid values.

23. The electronic device as claimed in claim 19, wherein the performing knowledge extraction on the original data table and the KPI data table comprises:
performing knowledge extraction according to corresponding associations between fields of the original data table and KPI fields of the KPI data table, summarizing and integrating the fields of the original data table and the KPI fields of the KPI data table into a plurality of vector matrices, and initializing weights in each vector matrix.

24. The electronic device as claimed in claim 23, wherein the constructing the association rule and generating the knowledge graph comprises:
determining the association rule based on a wireless communication network protocol, defining strengths of the associations by different weights according to the association rule, and assigning the weights to the plurality of vector matrices generated by the knowledge extraction; and
splitting the plurality of vector matrices into a plurality of triplets, wherein each of the plurality of triplets contains two associated fields and the weight in the vector matrix, and storing the triplets in a form of a graph, so as to generate a knowledge graph of the associations between a plurality of fields.

25. The electronic device as claimed in claim 24, wherein an assignment of the weights is input and filled through a visual interface or is loaded in bulk in a form of a text file.

26. The electronic device as claimed in claim 1, wherein the obtaining the initial data classification model by means of endogenous association inference comprises:
classifying fields in the original data table and the KPI data table through an association inference algorithm of a preset Markov logic network model, so as to form the initial data classification model.

27. The electronic device as claimed in claim 19, wherein the performing association inference on the initial data classification model according to demand fields which are input by a user, so as to output associated fields, calculating weights of associations between the associated fields and sorting the weights, and outputting a preferential association model comprises:
performing association inference on the demand fields which are input by the user, with the initial data classification model, and analysing and obtaining a plurality of association classes associated with the demand fields in the initial data classification model, and a plurality of associated fields associated with the demand fields in each association class;
calculating the weights of the associations between the associated fields associated with the demand fields, the associated fields comprising the fields of the original data table and the KPI fields; and
sorting the associated fields in each association class according to the weights of the associations, extracting a plurality of associated fields with larger weights and basic summary data tables where they are located, storing associated field names and table names of the plurality of associated fields with larger weights according to a predetermined data structure, and outputting the preferential association model.

28. The electronic device as claimed in claim 19, wherein the performing, according to the preferential association model, data extraction, transformation and loading from the basic summary data tables, so as to generate the data warehouse for the demand fields comprises:
writing a corresponding data Extract-Transform-Load (ETL) program according to the output preferential association model, wherein the data ETL program is configured to extract corresponding associated data in line with needs from the basic summary data tables, and respectively store the corresponding associated data in a form of KPI sub-tables of the association classes, and data sub-tables of the association classes; and the KPI sub-tables of the association classes, and the data sub-tables of the association classes constitute the data warehouse for the demand fields.
